(19) United States
(12) Patent Application Publication
(10) Pub. No.: US 2018/0165694 A1
(43) Pub. Date: Jun. 14, 2018

(54) EVALUATING PERFORMANCE OF APPLICATIONS UTILIZING USER EMOTIONAL STATE PENALTIES

(71) Applicant: ENTIT SOFTWARE LLC, Sunnyvale, CA (US)

(72) Inventors: Ola Galkin, Yehud (IL); Haim Shuvali, Yehud (IL); Amichai Nitsan, Yehud (IL)

(21) Appl. No.: 15/534,733

(22) PCT Filed: Dec. 17, 2014
(86) PCT No.: PCT/US2014/070817

§ 371 Date: Jun. 23, 2016

(51) Int. Cl. G06Q 30/02; G06F 8/10; G06F 8/77

(52) U.S. Cl. CPC G06Q 30/0201; G06F 8/77; G06F 8/10

(57) ABSTRACT

In one example of the disclosure, transaction data is accessed, the data transaction indicative of a user transaction with an application made via a computing device during a session. A first measurement of duration of the user transaction and a second measurement of duration of the session are determined based upon the transaction data. Expectation data indicative of a user expectation for duration of the transaction is accessed. A user emotional state penalty is determined based upon the first and second measurements and the user expectation.

### BACKGROUND

Many services are delivered to consumers via software applications. In examples, these software applications may be composite in that several software components work in combination to fulfill the service. The components themselves may be distributed across various physical and virtual devices. For instance, a smartphone, tablet, notebook or other user computing device may serve as a client side user interface component. Through that user interface component, a user may initiate a series of actions carried to be carried out by the user computing device and by server side components to fulfill the service.

### DRAWINGS

FIG. 1 is a block diagram depicting an example environment in which various examples of evaluation of performance of applications utilizing user emotional state penalties may be implemented.

FIG. 2 is a block diagram depicting an example of a system enabling evaluation of performance of applications utilizing user emotional state penalties.

FIG. 3 is a block diagram depicting an example data structure for a system to enable evaluation of performance of applications utilizing user emotional state penalties.

FIG. 4 is a block diagram depicting a memory resource and a processing resource to implement an example of enabling evaluation of performance of applications utilizing user emotional state penalties.

FIG. 5 illustrates an example of enabling evaluation of performance of applications utilizing user emotional state penalties.

FIG. 6 is a flow diagram depicting steps taken to implement an example of evaluation of application performance utilizing user emotional state penalties.

FIG. 7 is a flow diagram depicting steps taken to implement an example of evaluation of application performance utilizing user emotional state penalties based upon transactional data for a set of user transactions.

### DETAILED DESCRIPTION

INTRODUCTION: For a provider of a software application, understanding the user experience and users' satisfaction with the application are key factors to successful implementation. With such an understanding of user experience and satisfaction, the provider of the application can better evaluate the success or likely success of the software application and how to invest resources for future development. Existing tools to evaluate a user's experience with an application may measure one or more performance factors such as usability, stability, speed, and availability of its various components. For instance, a tool to evaluate user experience may measure different actions of an application such as network calls, data base queries, and predefined functional actions and make assessments based upon the measurements.

Such existing user experience evaluation tools typically operate within an assumed user context, e.g., a context that less waiting time for an application action is more preferable to a user than greater waiting time. However, in some instances an evaluation tool that estimates application performance without a dynamic consideration of user context can lead to erroneous conclusions. For instance, in certain situations a user will be an emotional state such that the user will prefer to wait a longer time for an application action to finish, where the additional time results in a more valuable result to the user and the context is such that the quality of the action result outweighs the tradeoff of additional time to reach the high quality result.

To address these issues, various examples described in more detail below provide a system and a method to evaluate performance of applications utilizing user emotional state penalties. In one example of the disclosure, transaction data is accessed, the transaction data indicative of a user transaction with an application made via a computing device during an application session. A first measurement of duration of the user transaction and a second measurement of duration of the session are determined based upon the transaction data. Expectation data indicative of a user expectation for duration of the transaction is accessed. A user emotional state penalty is determined in consideration of the first and second measurements and in consideration of the user expectation.

In another example of the disclosure, transaction data indicative of a set of user transactions with an application is accessed, wherein each transaction is a transaction made via a computing device during a particular session. A first measurement of duration of the user transaction and a second measurement of duration of the session are determined for each of the set of user transactions based upon the transaction data. Expectation data is accessed for each of the set of user transactions, the expectation data indicative of a user expectation for duration of the transaction. A user emotional state penalty is determined for each of the set of user transactions based upon the first and second measurements and the user expectation for duration of the applicable transaction.

In this manner, examples described herein can enable providers of software applications to determine user emotional state penalties and thereby assess success of an application in a manner that takes into consideration time spent by a user interacting with a software where the user is getting real value out of result of the application action. As the user emotional state penalties are determined in consideration of user expectations and application session time, the penalties can be reflective of application processing time in excess of time that a user spends consuming the results of an application transaction (e.g., search results). Disclosed examples present an automated and efficient manner for provision of recommendations to revise evaluated software applications, the recommendations made based upon the determined user emotional state penalties. Disclosed examples additionally present an automated and efficient manner for determination and provision of application performance scores for applications, a score being based upon a sum of user emotional state penalties determined for an applicable session. Thus, application providers' and developers' satisfaction with services that evaluate software application performance utilizing the disclosed examples, and with the software applications evaluated thereby, should increase. Further, user satisfaction with the physical and virtual devices that host or otherwise facilitate the software application evaluation services, and with the physical and virtual devices that host or facilitate the evaluated software application, should increase.

The following description is broken into sections. The first, labeled “Environment,” describes an environment in which various examples may be implemented. The second section, labeled “Components,” describes examples of various physical and logical components for implementing various examples. The third section, labeled “Illustrative Example,” presents an example of enabling evaluation of performance of applications utilizing user emotional state penalties. The fourth section, labeled “Operation,” describes steps taken to implement various examples.

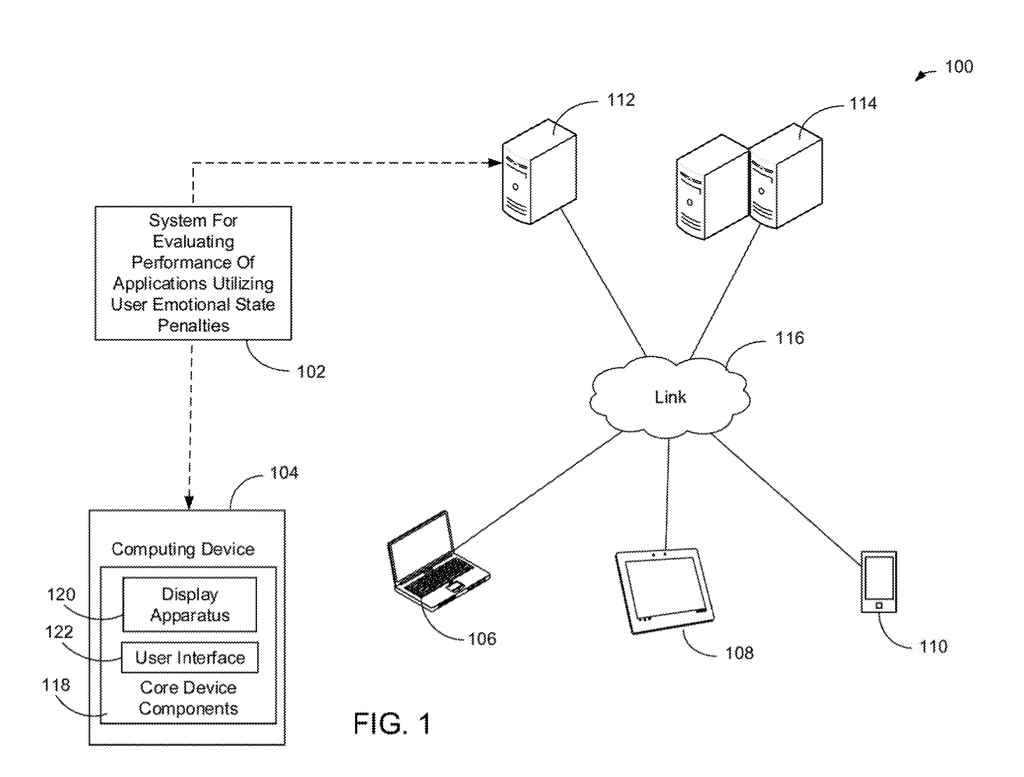

ENVIRONMENT: FIG. 1 depicts an example environment 100 in which examples may be implemented as a system 102 for evaluating performance of applications utilizing user emotional state penalties. Environment 100 is shown to include computing device 104, client devices 106, 108, and 110, server device 112, and server devices 114. Components 104-114 are interconnected via link 116.

Link 116 represents generally any infrastructure or combination of infrastructures to enable an electronic connection, wireless connection, other connection, or combination thereof, to enable data communication between components 104, 106, 108, 110, 112, and 114. Such infrastructure or infrastructures may include, but are not limited to, one or more of a cable, wireless, fiber optic, or remote connections via telecommunication link, an infrared link, or a radio frequency link. For example, link 116 may represent the internet, one or more intranets, and any intermediate routers, switches, and other interfaces. As used herein an “electronic connection” refers generally to a transfer of data between components, e.g., between two computing devices, that are connected by an electrical conductor. A “wireless connection” refers generally to a transfer of data between two components, e.g., between two computing devices, that are not directly connected by an electrical conductor. A wireless connection may be via a wireless communication protocol or wireless standard for exchanging data.

Client devices 106-110 represent generally any computing device with which a user may interact to communicate with other client devices, server device 112, and/or server devices 114 via link 116. Server device 112 represents generally any computing device to serve an application and corresponding data for consumption by components 104-110. Server devices 114 represent generally a group of computing devices collectively to serve an application and corresponding data for consumption by components 104-110.

Computing device 104 represents generally any computing device with which a user may interact to communicate with client devices 106-110, server device 112, and/or server devices 114 via link 116. Computing device 104 is shown to include core device components 118. Core device components 118 represent generally the hardware and programming for providing the computing functions for which device 104 is designed. Such hardware can include a processor and memory, a display apparatus 120, and a user interface 122. The programming can include an operating system and applications. Display apparatus 120 represents generally any combination of hardware and programming to exhibit or present a message, image, view, or other presentation for perception by a user, and can include, but is not limited to, a visual, tactile or auditory display. In examples, the display apparatus 120 may be or include a monitor, a touchscreen, a projection device, a touch/sensory display device, or a speaker. User interface 122 represents generally any combination of hardware and programming to enable interaction between a user and device 104 such that the user may effect operation or control of device 104. In examples, user interface 122 may be, or include, a keyboard, keypad, or a mouse. In some examples, the functionality of display apparatus 120 and user interface 122 may be combined, as in the case of a touchscreen apparatus that may enable presentation of images at device 104, and that also may enable a user to operate or control functionality of device 104.

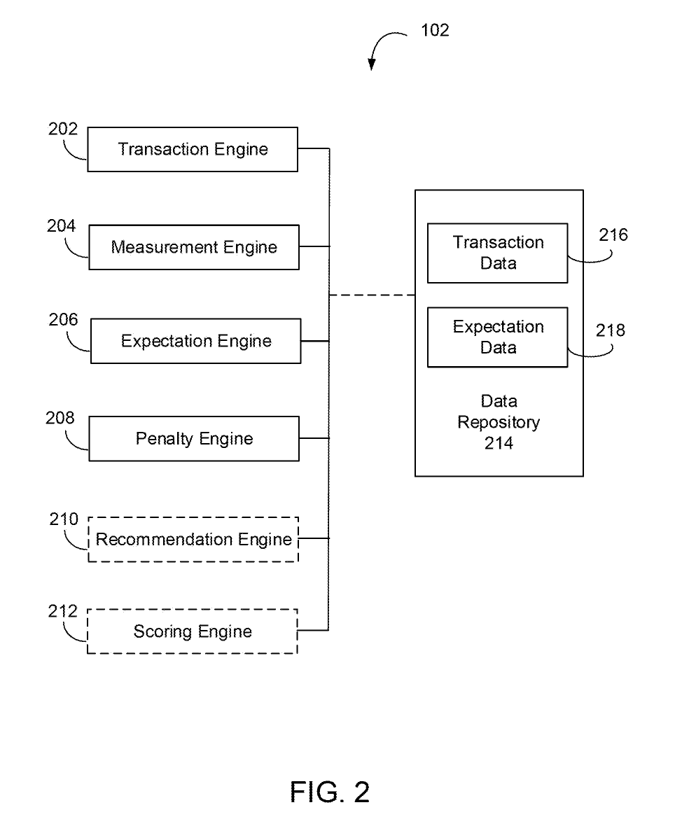

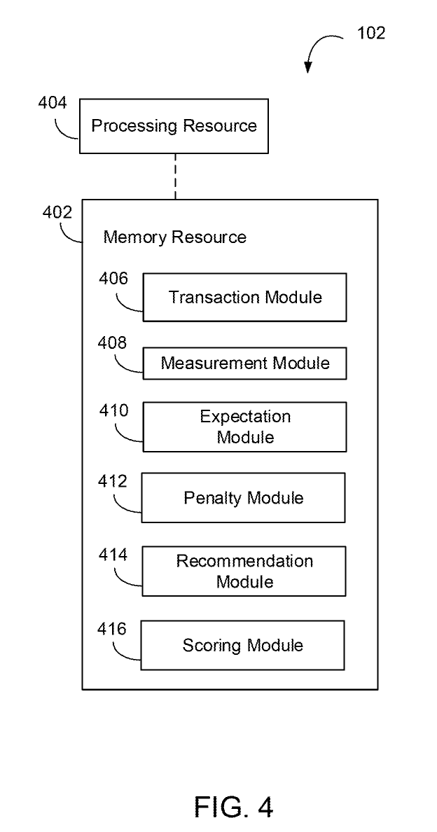

COMPONENTS: FIGS. 2-4 depict examples of physical and logical components for implementing various examples. In FIG. 2 various components are identified as engines 202, 204, 206, 208, 210, and 212. In describing engines 202, 204, 206, 208, 210, and 212 focus is on each engine's designated function. However, the term engine, as used herein, refers generally to a combination of hardware and programming to perform a designated function. As is illustrated later with respect to FIG. 4 the hardware of each engine, for example, may include one or both of a processor and a memory, while the programming may be code stored on that memory and executable by the processor to perform the designated function.

System 102, discussed in more detail below, represents generally a combination of hardware and programming to enable evaluation of performance of applications utilizing user emotional state penalties. In some examples, system 102 may be wholly integrated within core device components 118. In other examples, system 102 may be implemented as a component of any of computing device 104, client devices 106-110, server device 112, or server devices 114 where it may take action based in part on data received from core device components 118 via link 116. In other examples, system 102 may be distributed across computing device 104, and any of client devices 106-110, server device 112, or server devices 114. For example, components that implement accessing transaction data indicative of a user transaction with an application made via a computing device during an application session, and that implement determining a first measurement of duration of the user transaction and a second measurement of duration of the session based upon the transaction data, may be included within computing device 104. Continuing with this example, components that implement accessing expectation data indicative of a user expectation for duration of the transaction, and implement determining a user emotional state penalty based upon the first and second measurements and the user expectation, may be components included within a server device 112. Other distributions of system 102 across computing device 104, client devices 106-110, server device 112, and server devices 114 are possible and contemplated by this disclosure. It is noted that all or portions of system 102 to enable evaluation of performance of applications utilizing user emotional state penalties may also be included on client devices 106, 108 or 110.

FIG. 2 is a block diagram depicting components of a system 102 to enable evaluation of performance of applications utilizing user emotional state penalties. In this example, system 102 includes transaction engine 202, measurement engine 204, expectation engine 206, and penalty engine 208. In particular examples, system 102 may additionally include recommendation engine 210 and/or scoring engine 212. In performing their respective functions, engines 202, 204, 206, 208, 210, and 212 may access a data repository 214. Repository 214 represents generally any memory accessible to system 102 that can be used to store and retrieve data.

In an example, transaction engine 202 represents generally a combination of hardware and programming to access transaction data 216 indicative of a user transaction with an application made via a computing device during an application session. In examples, transaction engine 202 may access the transaction data via a networking protocol. The networking protocol utilized may include, but is not limited to, Transmission Control Protocol/Internet Protocol (“TCP/IP”), HyperText Transfer Protocol (“HTTP”), and/or Session Initiation Protocol (“SIP”). As used herein, an “application” refers generally to a web application, software application, firmware application, or other programming that executes at, or accessible at, a computing device. In examples the computing device may be a mobile computing device. As used herein, the terms “mobile computing device” and “mobile device” are used synonymously, and refer generally to any portable computing device. In examples, a mobile device may be, but is not limited to, a smartphone, tablet computer, notebook computer, or any other mobile computing device configured to send and receive data, and/or otherwise communicate with a computer hosting system 102 via link 116. As used herein, a “user transaction” refers generally to a user interaction or series of user interactions with a software application (e.g., via user giving commands or sending instructions to the application via a user interface at a computing device) to accomplish a specific task. Examples of user transactions include, but are not limited to, search transactions (e.g., a search via a search engine application for a definition for submitted word), a comparison transaction (e.g., a request sent to a retail application that the application concurrently provide cost and specifications for two or more products), an order transaction (e.g., a request sent to an application to return an ordered list of items), a purchase transaction (e.g., a request sent to a retail application to place an order for goods or services), and a payment transaction (e.g., a request sent to a retail application to make a payment for goods or services).

As used herein, an “application session” and a “session” are used synonymously, and refer generally to a period of user interaction with a software application wherein there is a sequential flow of user interactions with the application. In an example, the user actions may be user actions completing a task or several tasks. In one example, a mobile application a session could be defined a period in which there was a flow of user actions starting from application launch until ten minutes (configurable timeout) after it went to the background with no user (UI) activity. In another example, a session could be defined according to a standard defined period such as, in (state-full) web technology, a “http session”, or in Web 2.0 technology, from login/open app until logout/close, etc. Thus, some examples of the disclosure, a session may be a period of continuous user interaction, and in other examples a session may be a period of interrupted user interaction.

Measurement engine 204 represents generally a combination of hardware and programming to determine, based upon the transaction data 216, a first measurement of duration of the user transaction and a second measurement of duration of the application session. As described previously, in examples a session may be a period of continuous user interaction with the application being evaluated, or a period of interrupted user interaction with the application being evaluated.

In particular examples, measurement engine 204 in determining the second measurement may adjust an observed total session time by a diversion factor that reflects user access, at least partially concurrent with processing of the user transaction, of a second application at the computing device. A simple example of such diversion is a user at a mobile device that initiates a search transaction via a first application that is an industry search tool, and while processing of the search request executes, the user diverts to check his or her email. In an example, measurement engine 204 may, in determining the second measurement of total session time, adjust the observed total session time that is time from start to finish of the search by a diversion factor that reflects user access of the email application.

Expectation engine 206 represents generally a combination of hardware and programming to access expectation data 218 indicative of a user expectation for duration of the transaction. As used herein, a “user expectation” for duration of a transaction refers generally to any user belief or prediction as to the duration of the user transaction. In an example, the accessed user expectation for duration of a transaction may be a static user expectation threshold for all user actions. In another example, the user expectation may be an expectation established with respect to a type of user. For instance, a user that frequently interacts with a subject software application under evaluation may be treated as having a different user expectation for a transaction duration than a user that is new to the application. In another example, the user expectation may be an expectation specifically established with respect to the type of transaction. For example, a set of user expectations (e.g., a user expectation for “long” and “short” user transactions) may be established such that a “search” user action is expected to take longer than an “ordering” transaction. In yet another example, the user expectation for the duration of the user transaction may be a time frame established via a statistical baseline for user transaction durations.

Penalty engine 208 represents generally a combination of hardware and programming to determine a user emotional state penalty according to a function that includes as factors the first measurement of duration of the user transaction, the second measurement of duration of the application session, and the expectation data 218 indicative of the user expectation for duration of the transaction.

In a particular example, the penalty engine 208 may determine the user emotional state penalty according the function:

$$user emotional state penalty = \frac{transaction duration - user expectation for transaction duration}{session duration} .$$

Thus, in this example the determined user emotional state penalty reflects the user value from the content of the application as the user value is correlated to the total time the user spent in the application (e.g., reading, comparing results, etc.). The determined user emotional state penalty also reflects the measured time a user waited for a user transaction in comparison to the time the user expected to wait for it. In this example, a user transaction taking three seconds in a one minute application session will have a smaller determined user emotional state penalty than would the same user transaction with the same duration in a twenty second session. This example reflects an assumption that the user value for content produced by a user transaction increases with length of the session.

In examples of the disclosure, system 102 may include a recommendation engine 210. Recommendation engine 210 represents generally a combination of hardware and programming to provide a recommendation for revision of the subject application based upon the determined user emotional state penalty. For instance, if a user emotional state penalty determined with respect to a payment user transaction meets a predetermined size threshold, recommendation engine 210 may provide a recommendation for revision of the subject application based upon the penalty. In an example, recommendation engine 210 may provide the recommendation for display to a user or users, e.g., via a display at an application performance dashboard application.

In a particular example, penalty engine 208 may determine user emotional state penalties for at least two distinct user transactions, and recommendation engine 210 may provide recommendations for revision of the subject application with the recommendations prioritized according to relative size of the determined user emotional state penalties.

In examples, system 102 may include a scoring engine 212. Scoring engine 212 represents generally a combination of hardware and programming to determine an application performance score for the subject application based upon a sum of user emotional state penalties determined for the application session under review. In a particular example, scoring engine 212 may determine the application performance score utilizing the function “100−Σ penalties during session.” In examples, then, the recommendation provided by recommendation engine 210 may be based upon the application performance score determined by scoring engine 212.

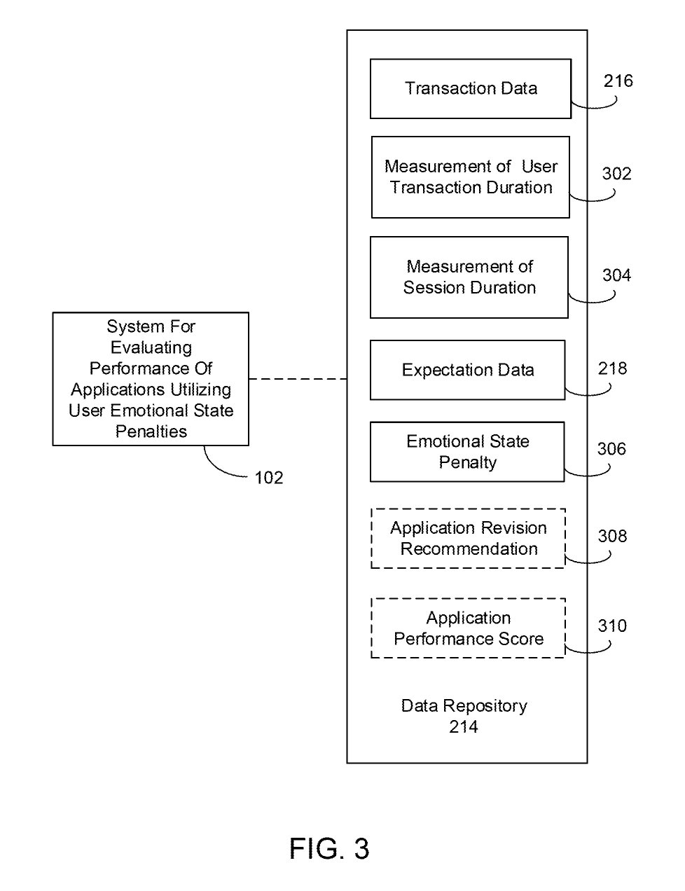

FIG. 3 depicts an example implementation of data repository 214. In this example, data repository 214 includes transaction data 216, data representative of a measurement of duration of a user transaction 302, data representative of a measurement of duration of an application session 304, user expectation data 218, an emotional state penalty 306, an application revision recommendation 308, and an application performance score 310.

Referring to FIG. 3 in view of FIG. 2, in one example, transaction engine 202 accesses transaction data 216 indicative of a set of user transactions with a subject application, wherein each user transaction was made via a computing device during a session. In certain examples, the set of user transactions may include user transactions initiated by different users, e.g., at different computing devices and during distinct sessions. In other examples, the set of user transactions may include user transactions initiated by a same user during same or distinct sessions. Measurement engine 204 determines for each of the set of user transactions, based upon the transaction data 216, a measurement 302 of duration of the user transaction and a measurement 304 of duration of the session. Expectation engine 206, for each of the set of user transactions, accesses expectation data 218 indicative of a user expectation for duration of the user transaction. Penalty engine 208, for each of the set of user transactions, determines a user emotional state penalty 306 based upon the measurement 302 of the transaction duration, the measurement 304 of session duration, and the expectation data 218 indicative of a user expectation for duration of the transaction. Recommendation engine 210 provides an application revision recommendation 308 for revision of the subject application based upon the determined user emotional state penalties 306.

In an example, recommendation engine 210 may provide a set of recommendations 308 for revision of the application, and prioritize the recommendation set according to size of the user emotional state penalty 306 associated with each of the recommendations within the set.

In another example, system 102 may include a scoring engine 212 to determine an application performance score 310 for the subject application based upon a sum of user emotional state penalties 306 determined for the session. The application revision recommendation 308 may be based upon an average of application performance scores 310 for sessions occurring within a defined time frame.

In a particular example, recommendation engine 210 calculates the effect of a first transaction type from the set of user transactions upon the application performance score 310. The application revision recommendation 308 provided by the recommendation engine 210 is prioritized according to size of associated user emotional state penalties of the first transaction type relative to user emotional state penalties associated with other transaction types. For instance, in an example wherein recommendation engine 210 may provide application revision recommendation 308 that are prioritized according to size of associated user emotional state penalties to give search type transactions a higher priority than payment type and ordering type transactions, where the user emotional state penalties associated with the search transaction type are greater than the user emotional state penalties associated with the payment and ordering transaction types. In a particular example, recommendation engine 210 may calculate the effect of a particular transaction type from the set of user transactions upon the application performance score 310 utilizing the function

$$effect of transaction type = \frac{\sum penalties associated with transaction type}{\sum sessions} .$$

In the foregoing discussion of FIGS. 2 and 3, engines 202, 204, 206, 208, 210, and 212 were described as combinations of hardware and programming. Engines 202, 204, 206, 208, 210, and 212 may be implemented in a number of fashions. Looking at FIG. 4 the programming may be processor executable instructions stored on a tangible memory resource 402 and the hardware may include a processing resource 404 for executing those instructions. Thus memory resource 402 can be said to store program instructions that when executed by processing resource 404 implement system 102 of FIGS. 2 and 3.

Memory resource 402 represents generally any number of memory components capable of storing instructions that can be executed by processing resource 404. Memory resource 402 is non-transitory in the sense that it does not encompass a transitory signal but instead is made up of more or more memory components to store the relevant instructions. Memory resource 402 may be implemented in a single device or distributed across devices. Likewise, processing resource 404 represents any number of processors capable of executing instructions stored by memory resource 402. Processing resource 404 may be integrated in a single device or distributed across devices. Further, memory resource 402 may be fully or partially integrated in the same device as processing resource 404, or it may be separate but accessible to that device and processing resource 404.

In one example, the program instructions can be part of an installation package that when installed can be executed by processing resource 404 to implement system 102. In this case, memory resource 402 may be a portable medium such as a CD, DVD, or flash drive or a memory maintained by a server from which the installation package can be downloaded and installed. In another example, the program instructions may be part of an application or applications already installed. Here, memory resource 402 can include integrated memory such as a hard drive, solid state drive, or the like.

In FIG. 4, the executable program instructions stored in memory resource 402 are depicted as transaction module 406, measurement module 408, expectation module 410, penalty module 412, recommendation module 414, and scoring module 416. Transaction module 406 represents program instructions that when executed by processing resource 404 may perform any of the functionalities described above in relation to transaction engine 202 of FIG. 2. Measurement module 408 represents program instructions that when executed by processing resource 404 may perform any of the functionalities described above in relation to measurement engine 204 of FIG. 2. Expectation module 410 represents program instructions that when executed by processing resource 404 may perform any of the functionalities described above in relation to expectation engine 206 of FIG. 2. Penalty module 412 represents program instructions that when executed by processing resource 404 may perform any of the functionalities described above in relation to penalty engine 208 of FIG. 2. Recommendation module 414 represents program instructions that when executed by processing resource 404 may perform any of the functionalities described above in relation to recommendation engine 210 of FIG. 2. Scoring module 416 represents program instructions that when executed by processing resource 404 may perform any of the functionalities described above in relation to scoring engine 212 of FIG. 2.

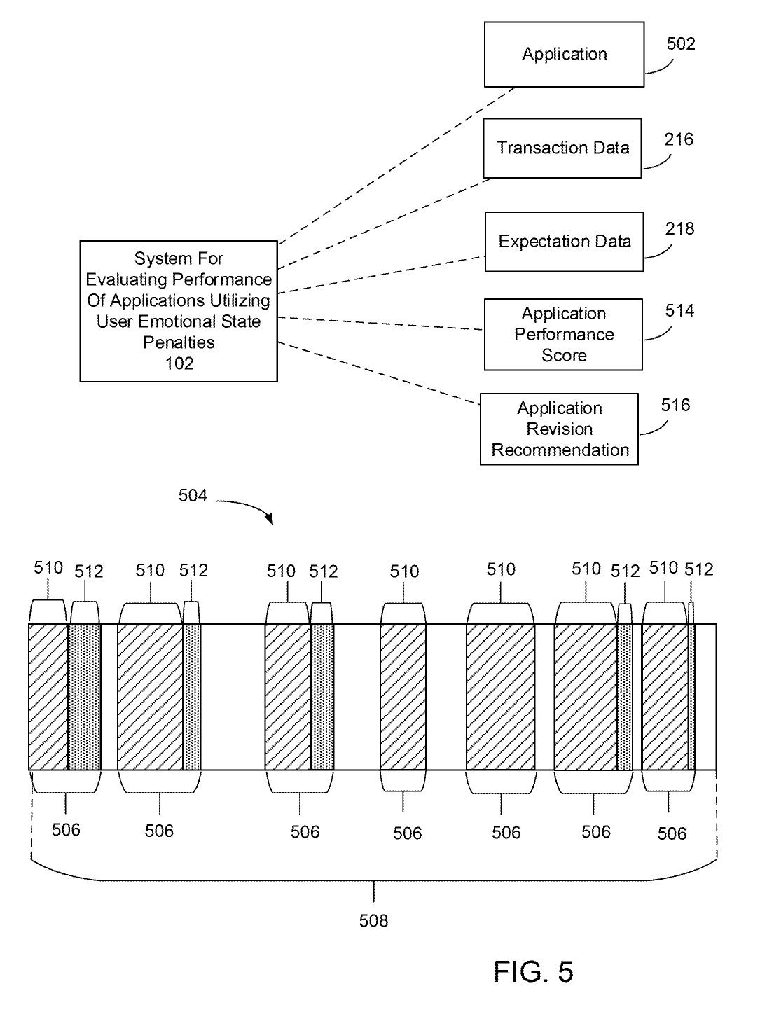

ILLUSTRATIVE EXAMPLE: FIG. 5, in view of FIG. 1, illustrates an example of system 102 enabling evaluation of application performance utilizing user emotional state penalties. In an example, a user causes a smartphone mobile computing device 110 (FIG. 1) to access a subject mobile application 502 that may interact with a server system 114 (FIG. 1) over an internet 116 (FIG. 1). In this example the subject application 502 is a hotel booking application/web site, and the user is executing searches to find hotels that fit the user's requirements.

Continuing with the example of FIG. 5, system 102, hosted at application evaluation server 112, accesses transaction data 216. The transaction data 216 is indicative of a set of transactions 504 by the user with the subject application 502 made via the smartphone 110 during an application session. The searches might be short and find few hotels, or the searches could be longer and as a result return a longer list of hotels which better suits the user's needs. In traditional performance measurements the shorter searches could be considered as better. However, from the user's point of view waiting a few extra few seconds will be worth where as a result of the extra time the user gains access to quality content that gives the user the value the user expected.

Examples of the disclosure enable evaluation of performance of the subject application 502 utilizing user emotional state penalties. For each user transaction among the set of user transactions 504, system 102 determines, based upon the transaction data 216, a first measurement of duration of the user transaction 506 and a second measurement of duration of the application session 508. For each transaction among the set of user transactions 504, system 102 accesses expectation data 218 indicative of a user expectation 510 for duration of the transaction. For each transaction among the set of user transactions 504, system 102 determines a user emotional state penalty 512 based upon the first 506 and second 508 measurements and the user expectation 510 for duration of the transaction. In this example, only user transactions that breach the user expectation for duration receive a penalty. As penalties are determined in consideration of user expectations and session time, the penalties are reflective of application processing time in excess of time the user spent consuming the results (e.g., search results).

In this example, since the penalties are normalized by the application session duration 508, each emotional state penalty is bounded by the function

0≤penalty≤100.

In an example, system 102 may determine an application performance score 514 for the subject application 502 based upon a sum of the user emotional state penalties 512 determined for the session 508, e.g., utilizing the function

100−Σpenalties during session.

System 102 may in turn provide a recommendation 516 for revision of the subject application 502 based upon the determined application performance score 514.

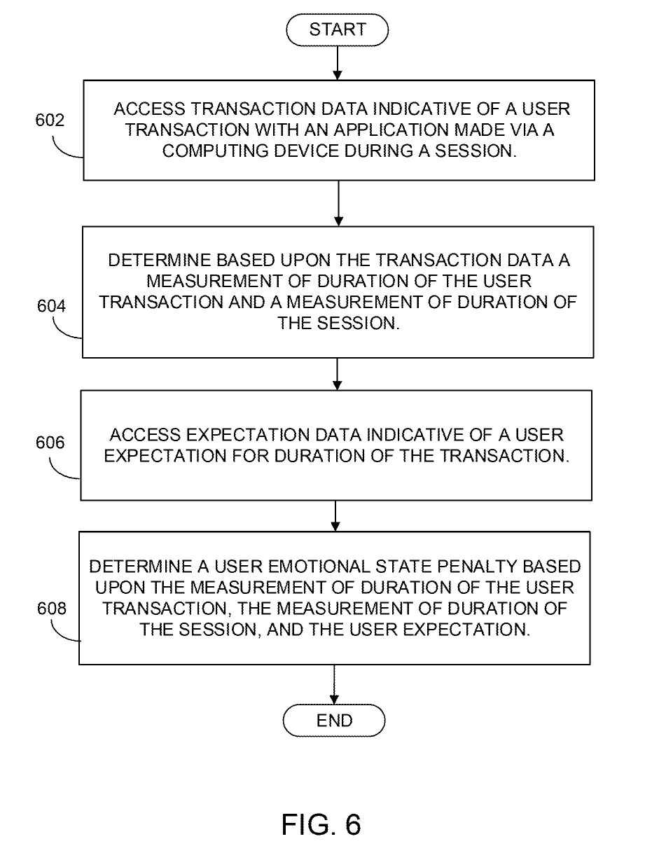

OPERATION: FIG. 6 is a flow diagram of steps taken to implement a method for evaluation of performance of applications utilizing user emotional state penalties. In discussing FIG. 6, reference may be made to the components depicted in FIGS. 2 and 4. Such reference is made to provide contextual examples and not to limit the manner in which the method depicted by FIG. 6 may be implemented. Transaction data is accessed, the transaction data indicative of a user transaction with an application made via a computing device during a session (block 602). Referring back to FIGS. 2 and 4, transaction engine 202 (FIG. 2) or transaction module 406 (FIG. 4), when executed by processing resource 404, may be responsible for implementing block 602.

A measurement of duration of the user transaction and a measurement of duration of the session are determined based upon the transaction data (block 604). Referring back to FIGS. 2 and 4, measurement engine 204 (FIG. 2) or measurement module 408 (FIG. 4), when executed by processing resource 404, may be responsible for implementing block 604.

Expectation data indicative of a user expectation for duration of the transaction is accessed (block 606). Referring back to FIGS. 2 and 4, expectation engine 206 (FIG. 2) or expectation module 410 (FIG. 4), when executed by processing resource 404, may be responsible for implementing block 606.

A user emotional state penalty is determined based upon the measurement of duration of the user transaction, the measurement of duration of the session, and the user expectation (block 608). Referring back to FIGS. 2 and 4, penalty engine 208 (FIG. 2) or penalty module 412 (FIG. 4), when executed by processing resource 404, may be responsible for implementing block 608.

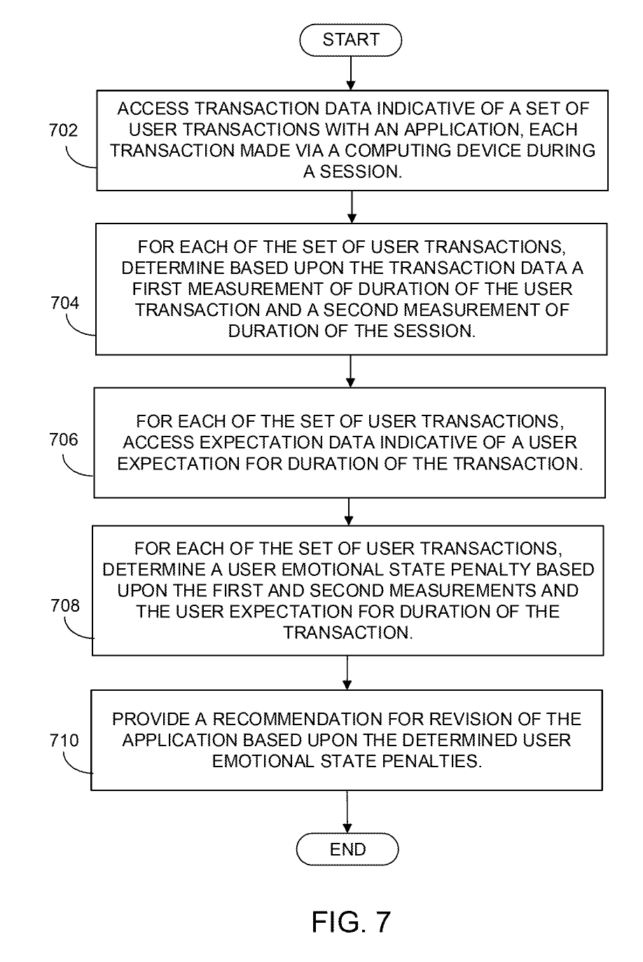

FIG. 7 is a flow diagram of steps taken to implement a method for evaluation of performance of applications utilizing user emotional state penalties. In discussing FIG. 7, reference may be made to the components depicted in FIGS. 2 and 4. Such reference is made to provide contextual examples and not to limit the manner in which the method depicted by FIG. 7 may be implemented. Transaction data indicative of a set of user transactions with an application is accessed, each transaction made via a computing device during a session (block 702). Referring back to FIGS. 2 and 4, transaction engine 202 (FIG. 2) or transaction module 406 (FIG. 4), when executed by processing resource 404, may be responsible for implementing block 702.

For each of the set of user transactions, a first measurement of duration of the user transaction and a second measurement of duration of the session are determined based upon the transaction data (block 704). Referring back to FIGS. 2 and 4, measurement engine 204 (FIG. 2) or measurement module 408 (FIG. 4), when executed by processing resource 404, may be responsible for implementing block 704.

For each of the set of user transactions, expectation data indicative of a user expectation for duration of the transaction is accessed (block 706). Referring back to FIGS. 2 and 4, expectation engine 206 (FIG. 2) or expectation module 410 (FIG. 4), when executed by processing resource 404, may be responsible for implementing block 706.

For each of the set of user transactions, a user emotional state penalty is determined based upon the first and second measurements and the user expectation for duration of the transaction (block 708). Referring back to FIGS. 2 and 4, penalty engine 208 (FIG. 2) or penalty module 412 (FIG. 4), when executed by processing resource 404, may be responsible for implementing block 708.

A recommendation for revision of the application is provided based upon the determined user emotional state penalties (block 710). Referring back to FIGS. 2 and 4, recommendation engine 210 (FIG. 2) or recommendation module 414 (FIG. 4), when executed by processing resource 404, may be responsible for implementing block 710.

CONCLUSION: FIGS. 1-7 aid in depicting the architecture, functionality, and operation of various examples. In particular, FIGS. 1-4 depict various physical and logical components. Various components are defined at least in part as programs or programming. Each such component, portion thereof, or various combinations thereof may represent in whole or in part a module, segment, or portion of code that comprises one or more executable instructions to implement any specified logical function(s). Each component or various combinations thereof may represent a circuit or a number of interconnected circuits to implement the specified logical function(s). Examples can be realized in any memory resource for use by or in connection with processing resource. A “processing resource” is an instruction execution system such as a computer/processor based system or an ASIC (Application Specific Integrated Circuit) or other system that can fetch or obtain instructions and data from computer-readable media and execute the instructions contained therein. A “memory resource” is any non-transitory storage media that can contain, store, or maintain programs and data for use by or in connection with the instruction execution system. The term “non-transitory” is used only to clarify that the term media, as used herein, does not encompass a signal. Thus, the memory resource can comprise any one of many physical media such as, for example, electronic, magnetic, optical, electromagnetic, or semiconductor media. More specific examples of suitable computer-readable media include, but are not limited to, hard drives, solid state drives, random access memory (RAM), read-only memory (ROM), erasable programmable read-only memory, flash drives, and portable compact discs.

Although the flow diagrams of FIGS. 6 and 7 show specific orders of execution, the orders of execution may differ from that which is depicted. For example, the order of execution of two or more blocks or arrows may be scrambled relative to the order shown. Also, two or more blocks shown in succession may be executed concurrently or with partial concurrence. All such variations are within the scope of the present disclosure.

The present disclosure has been shown and described with reference to the foregoing examples. It is to be understood, however, that other forms, details and examples may be made without departing from the spirit and scope of the invention that is defined in the following claims. All of the features disclosed in this specification (including any accompanying claims, abstract and drawings), and/or all of the steps of any method or process so disclosed, may be combined in any combination, except combinations where at least some of such features and/or steps are mutually exclusive.

What is claimed is:

1. A system to evaluate performance of applications utilizing user emotional state penalties, comprising:
a transaction engine, to access transaction data indicative of a user transaction with an application made via a computing device during a session;
a measurement engine, to determine based upon the transaction data a first measurement of duration of the user transaction and a second measurement of duration of the session;
an expectation engine, to access expectation data indicative of a user expectation for duration of the transaction; and
a penalty engine, to determine a user emotional state penalty based upon the first and second measurements and the user expectation.

2. The system of claim 1, wherein the user transaction is one of a search transaction, a comparison transaction, an order transaction, a purchase transaction, and a payment transaction.

3. The system of claim 1, wherein the penalty engine is to determine the user emotional state penalty according a function wherein the difference between the first measurements and the user expectation is divided by the session duration.

4. The system of claim 1,
wherein the application is a first application, and
wherein the measurement engine, in determining the second measurement, adjusts an observed total session time by a diversion factor indicative of user access, at least partially concurrent with processing of the user transaction, of a second application at the computing device.

5. The system of claim 1, further comprising a recommendation engine, to provide a recommendation for revision of the application based upon the user emotional state penalty.

6. The system of claim 5, wherein the penalty engine is to determine user emotional state penalties for distinct user transactions, and wherein the recommendation engine is to provide a plurality of recommendations for revision of the application, the recommendations prioritized according to relative size of the determined user emotional state penalties.

7. The system of claim 5,
wherein the user emotional state penalty is a first penalty;
further comprising a scoring engine to determine an application performance score for the application based upon a sum of user emotional state penalties determined for the session, the sum including the first penalty; and
wherein the revision recommendation is based upon the application performance score.

8. The system of claim 7, wherein the scoring engine is to determine the application performance score utilizing a function wherein a sum of user emotional state penalties for a session is subtracted from 100.

9. A memory resource storing instructions that when executed cause a processing resource to implement a system for evaluation of performance of applications utilizing user emotional state penalties, the instructions comprising:
a transaction module that when executed causes the processing resource to access transaction data indicative of a plurality of user transactions with an application, each transaction made via a computing device during a session;
a measurement module that when executed causes the processing resource to, for each of the plurality of user transactions, determine based upon the transaction data a first measurement of duration of the user transaction and a second measurement of duration of the session;
an expectation module that when executed causes the processing resource to for each of the plurality of user transactions, access expectation data indicative of a user expectation for duration of the transaction;
a penalty module that when executed causes the processing resource to, for each of the plurality of user transactions, determine a user emotional state penalty based upon the first and second measurements and the user expectation for duration of the transaction; and
a recommendation module that when executed causes the processing resource to provide a recommendation for revision of the application based upon the determined user emotional state penalties.

10. The memory resource of claim 9, wherein the plurality of user transactions include user transactions initiated by different users.

11. The memory resource of claim 9,
further comprising a scoring module that when executed causes the processor to, for each session, determine an application performance score for the application based upon a sum of user emotional state penalties determined for the session, and
wherein the revision recommendation is based upon an average of application performance scores for sessions occurring within a defined time frame.

12. The memory resource of claim 9, wherein the recommendation module when executed provides a plurality of recommendations for revision of the application, the recommendations prioritized according to size of associated user emotional state penalties.

13. The memory resource of claim 9, wherein the recommendation module when executed calculates the effect of a first transaction type from the plurality of user transactions upon the application performance score, and the revision recommendation is prioritized according to size of associated user emotional state penalties of the first transaction type relative to user emotional state penalties associated with other transaction types.

14. The memory resource of claim 13, wherein the recommendation module when executed calculates the effect of a first transaction type from the plurality of user transactions upon the application performance score utilizing a function wherein a sum of user emotional penalties associated with a transaction type is divided by a sum of sessions.

15. A method to evaluate application performance utilizing user emotional state penalties, comprising:
receiving first data indicative of a plurality of user transactions within an application, each transaction made via a computing device during a session;
for each of the plurality of user transactions,
determining based upon the first data a measurement of duration of the user transaction and a measurement of duration of the session;
accessing second data indicative of a user expectation for duration of the transaction;
determining a user emotional state penalty based upon the measurement of duration of the user transaction, the measurement of duration of the session, and the user expectation for duration of the transaction; and
providing a plurality of recommendations for revision of the application, the recommendations prioritized according to relative amount of the associated user emotional state penalties.
